(19) United States
(12) Patent Application Publication
(10) Pub. No.: US 2019/0053515 A1
(43) Pub. Date: Feb. 21, 2019

(54) FOOD PRODUCT SERVING DEVICE AND SERVING CONTAINERS

(71) Applicants: Nenad Stojkovski, Northville, MI (US); Sandy Stojkovski, Northville, MI (US)

(72) Inventors: Nenad Stojkovski, Northville, MI (US); Sandy Stojkovski, Northville, MI (US)

(21) Appl. No.: 16/075,798

(22) PCT Filed: Feb. 8, 2017
(86) PCT No.: PCT/US2017/016987

§ 371 Date: Aug. 6, 2018

Related U.S. Application Data
(60) Provisional application No. 62/292,992, filed on Feb. 9, 2016.

(51) Int. Cl. A23G 9/28; B67D 7/02

(52) U.S. Cl. CPC A23G 9/28; B67D 7/02

(57) ABSTRACT

A device, container, and method for dispensing a semi-solid flowable food product from within a container comprising. The device may include a receptacle adapted for retaining the container and a plunger. The plunger and/or receptacle may toward the other to compress the container and extrude the semi-solid flowable product. The container may include a compressible wall and an insert. The insert may include an opening from which the semi-solid flowable product may be dispensed.

### FIELD

The present disclosure relates to a self-serve machine, containers for use with the self-serve machine, and methods of using both. The self-serve machine may cooperate with the container by compressing the container to extrude a semi-solid flowable food product. A semi-solid flowable food product may be an individual serving of a soft serve dessert, such as ice-cream, frozen yogurt, and gelato.

### BACKGROUND

There are several designs of machines in the commercial market that enable serving of soft serve ice cream and frozen yogurt at the point of purchase. The point of purchase may include an ice cream or frozen yogurt store. These machines are mini factories that provide mixing ingredients, adding air to the mixture, cooling the mix for storing at a cool temperature, and cooling the mix even further for ultimately serving the dessert. These machines are therefore large and expensive, making them impractical for general consumers outside of commercial use. The usage is also limited to larger batches of dessert mixes that require clean up and disinfection prior to change over between different mixes. There have been attempts to make machines that can provide individually wrapped dessert pods like the One-Shot® machine by the One-Shot Ice Cream Corporation, with associated hard plastic cups. Notwithstanding the above, there appears to be an absence of a self-serve machine for soft serve desserts which is not bulky nor designated for commercial use at businesses such as restaurants, convenience stores, markets, and the like.

It would be attractive to have a machine for dispensing a dessert, such as a frozen dessert, which is able to be used in a consumer's residence. What is needed is a dispensing machine which is small enough to be used within the home, which is able to be easily cleaned, which works with single serving dessert containers, and requires minimal processing. It would be attractive to have a container for storing food product, such as a flowable food product, which is compatible with a dispensing device. What is needed is a container which can be purchased at a local retail store, delivered via a residential delivery service, stored in a regular grade freezer, inserted into the dispensing device, cooperates with the device to extrude a flowable food product from the container into a serving container, removable from the device, and/or disposable with minimal clean-up required.

### SUMMARY

The present disclosure relates to a container comprising: (i)one or more walls having a wall thickness of at least about 1.5 mil; (ii) one or more inserts having an insert thickness that is greater than the wall thickness in a ratio of at least about 10:1; (iii) one or more insert openings formed in the one or more inserts; wherein the one or more insert openings are adapted to transfer an amount of a flowable food product from within the container to a location exterior of the container; and wherein the flowable food product is semi-solid.

The present disclosure relates to a method of using a container including: (i) locating the container into a receptacle of a device having a complimentary shape for receiving the container; (ii) moving the container and receptacle toward and into contact with a plunger of the device and/or moving the plunger toward the receptacle and toward and into contact with container; and (iii) compressing the one or more walls of the container by continued movement of the plunger and/or the receptacle so that the flowable food product is extruded from the container via the one or more insert openings and the one or more wall openings.

The present disclosure relates to a device for dispensing a semi-solid flowable food product from within a container comprising: (i) a frame; (ii) a receptacle connected to the frame and adapted for retaining the container; (iii) a plunger connected to the frame which is opposing and centered with the receptacle, wherein the plunger is adapted to be received within the receptacle; (iv) an actuator assembly within the frame which is in communication with the receptacle, the plunger, or both and is adapted to generate movement of the receptacle, the plunger, or both; and wherein movement of the receptacle and/or the plunger is relative to the other so that the plunger is able to be received within the receptacle to compress the container and extrude the semi-solid flowable food product.

The teachings of the disclosure provide for a dispensing device, which may be able to be placed on a table, counter surface, or other surface of a consumer's residence. The device may have a height which may fit between a counter top and an upper cabinet, such as within a kitchen of a residential home. The device may have removable components for easily cleaning or sanitizing components, such as for reuse. The device may work with single serving containers, such as containers as taught herein. The device may compress a container to extrude a flowable food product into a serving container.

The container of the teachings herein may store a flowable food product and may be compatible with a dispensing device for extruding the flowable food product. The container of may be suitable for storing in freezing temperatures, such as a freezer in a retail store or a home. The container may include an opening to guide the flow of a flowable product, such as in a swirl shape into a serving container. The container may include an opening which may guide the flow of a flowable food product, such that when the food product is extruded from the container, the product does not come into contact with the device.

The teachings herein may also provide a method for using the container, the device, or both to extrude a flowable food product into a serving container.

### BRIEF DESCRIPTION OF DRAWINGS

FIG. 1A illustrates a side of a device which may dispense a flowable food product from a container.

FIG. 1B illustrates a side of a device after dispensing a flowable food product from a container into a serving container.

FIG. 2 illustrates a side of a device which may dispense a flowable food product from a container.

FIG. 3 illustrates a front view of a device which may dispense a flowable food product.

FIG. 4 illustrates a cross-section of a container.

FIG. 5 illustrates a cross-section of a container with a nozzle.

FIG. 6 illustrates a perspective view of a wall of a container.

FIG. 7 illustrates a perspective view of an insert of a container.

FIG. 8 illustrates a perspective view of an insert of a container.

FIG. 9 illustrates a side view of a container.

FIG. 10 illustrates a perspective view of a container.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings relate to a container which may be able to store a flowable food product and may be adapted to transfer an amount of the flowable food product. The container may be suitable for storing and/or transferring a single-serving of a flowable food product. The container may be reusable, single use, disposable, recyclable, biodegradable, refillable, the like, or any combination thereof. The container may be adapted for transferring the flowable food product to a location exterior of the container, such as a serving container. The container may find particular use in the storage and serving of flowable food products, which may include semi-solid flowable food products. The flowable food products may include desserts. Desserts may include ice-cream, frozen yogurt, gelato, pudding, gelatin, fruit purees, the like, or a combination thereof. The container may be easily stored within a food storage enclosure. A food storage enclosure may include a freezer, such as a home a freezer for consumer use. The container may be any size or shape suitable for storing and dispensing a flowable food product. For example, the container may be cylindrical, trapezoidal, triangular, square, rectangular, pouch-like, the like, or any combination thereof. The container may be at least partially hollow to provide for space to enclose flowable food product. The container may have a hollow interior. The hollow interior may be useful for storing a flowable food product. The container may be suitable for a single use (i.e., single serving) or multiple uses (i.e., multiple servings). The container may have any interior useable volume suitable for storing at least one serving size of flowable food product for dispensing, such as a half cup serving size a dessert. An interior suitable volume may contain one or more servings, two or more servings, or even four or more servings. An interior suitable volume may container eight or less servings, six or less servings, or even five or less servings. An interior suitable volume may retain The container may have an interior suitable volume of at least about 1 oz., at least about 2 oz., at least about 4 oz., or even at least about 6 oz. The container may have an interior suitable volume of less than about 16 oz., less than about 14 oz., less than about 12 oz., or even less than about 10 oz. The container may be suitable as a storage container for a flowable food product and a serving container for a flowable food product. The container may include a first portion and a second portion packaged together. The first portion may be removably inserted within the second portion. The first portion may be a container portion inserted into a device for serving a flowable food product. The second portion may be placed onto the device to receive the flowable food product from the first portion. The container may be at least partially compressible, deformable, and/or flexible. The container may be at least partially rigid, stiff, uncompressible, undeformable, and/or inflexible. The container may guide the flow of the flowable food product such that the flowable food product is provided in a swirl pattern into a serving container and/or avoids contact with the device during extrusion. For example, the container may guide the flow of the flowable food product in a vortex motion. To enclose the flowable food product, the container may include one or more walls.

The container may include one or more walls. A wall may function to enclose, encapsulate, or store a flowable food product. A wall may function to guide the flowable food product out of the container. A wall may cooperatively work with a device for serving the flowable food product into a serving container. A wall may have any shape to enclose a flowable food product. One or more walls may have a cross-section shape which is square, rectangular, oval, elliptical, circular, triangular, the like, or any combination thereof. One or more walls may be shaped like a cup, pouch, or the like. One or more walls may define a hollow interior of the container. One or more walls may be compressible, incompressible, or both. One or more walls may be flexible, substantially rigid, or both. One or more walls may be made from one or more wall materials. One or more walls may be sealed with one or more other walls. By being sealed, one or more walls may prevent a flowable food product from being exposed to an ambient environment. One or more walls may enclose at least partially, or substantially the entirety of at least one insert of the container. One or more walls may include one or more first walls, bottom end walls, sealing walls, openings, or any combination thereof.

A wall of the container may include one or more first walls. The one or more first walls may function to enclose about a flowable food product, compress or deform to dispense a flowable food product, or both. A first wall may have a three-dimensional shape which is substantially cylindrical, cubed, prismed, trapezoidal, elliptical, triangular, planar, the like, or any combination thereof. One or more first walls may include a single first wall or a plurality of first walls. A first wall may be cylindrical and encircle about a hollow interior of the container. A first wall may be sealed to and/or integral with one or more other walls. A first wall may be sealed to one or more first walls, sealing walls, bottom end walls, or any combination thereof. A first wall may be sealed to one or more other walls at one or more flanges, edges, perimeters, or any combination thereof. A first wall may be sealed to one or more other walls via an adhesive, vacuum forming, heat sealing, the like, or any combination thereof. One first wall may be opposing and sealed to another first wall to form a hollow interior of the container. The first wall may extend from a bottom end to a top end of the container. The first wall may be adjacent, opposing, connected to, parallel with another one or more walls. One or more walls may include a first wall, a bottom end wall, a sealing wall, or any combination thereof.

A wall of the container may include one or more bottom end walls. A bottom end wall may function to cooperate with one or more other walls to retain a flowable food product within the container, to allow dispensing of a flowable food product from the container, or both. A bottom end wall may have any size and/or shape to cooperate with a receptacle of a device, an insert of the container, a tab of the container, or any combination thereof to store and dispense a flowable food product. A bottom end wall may have a cross-section which is circular, square, rectangular, elliptical, ovular, triangular, the like, or any combination thereof. For example, a bottom end wall may be disc-shaped or rectangular panel-shaped. A bottom end wall may be concave, convex, substantially planar, the like, or any combination thereof. A bottom end wall may be concave and circular. A bottom end wall may have a width (e.g., diameter) smaller than, about equal to, or greater than one or more other walls. A bottom end wall may be located on a top, bottom, or side of the container. The bottom end wall may be adjacent to, opposing, connected, parallel, perpendicular, off-set, or any combination thereof relative to one or more other walls. The bottom end wall may extend generally perpendicularly from one or more walls, such as a first wall. One or more walls may extend from about an entire periphery of the bottom end wall. For example, a first wall may project from about an entire periphery of the bottom end wall. The bottom end wall may be a separate piece or integral with one or more other walls. The bottom end wall may be integral with a first wall. The bottom end wall may include one or more openings. The bottom end wall may be opposite a sealing wall.

A wall of the container may include one or more sealing walls. One or more sealing walls may function to close and/or seal the container, prevent a flowable food product from being exposed to an ambient environment, receive and transfer a force from a device to the container and/or flowable food product, or any combination thereof. A sealing wall may have a shape similar or different than a shape of a bottom end wall. A sealing wall may have a cross-section which is circular, square, rectangular, elliptical, ovular, triangular, the like, or any combination thereof. A sealing wall may be located on a top, bottom, or sides of the container. A sealing wall may be a cover for the container located at a top end. A sealing may be curved, planar, or both. A sealing wall may have a width and/or thickness less than, about equal to, or greater than one or more other walls. A sealing wall may be located adjacent, opposing, parallel, perpendicular, off-set, or any combination thereof from one or more other walls. A sealing wall may be substantially opposing, distanced from, and/or parallel to a bottom end wall. A sealing wall may be adjacent and/or perpendicular to a first wall. A sealing wall may be a separate piece, integral with, and/or adhered to one or more other walls. A sealing wall may be a separate piece and adhered to a first wall. A sealing wall may be adhered to a first wall at one or more edges, flanges, a perimeter, or any combination thereof. The sealing wall may be adhered to the first wall after a flowable food product is located within a hollow interior of the container. A sealing wall may provide a surface for a compressive force to be applied to the container. The compressive force may be a force by a plunger. The sealing wall may be made of one or more wall materials.

One or more walls may be made of one or more wall materials. One or more walls may be made from the same or different wall materials as one or more other walls. One or more wall materials may function to enclose and/or protect a flowable food product, prevent one or more flowable food products from being exposed to and/or being damaged by an ambient environment, cooperate with a device to dispense of a flowable food product, or any combination thereof. The one or more walls may be made of any suitable material which may be compressible, deformable, flexible, safe for contact with a flowable food product, prevent contaminants from entering the container, safe for freezing storage temperatures, biodegradable, recyclable, the like, or any combination thereof. One or more walls may be made of any suitable material for long-term food storage conditions, such as freezing temperatures within a freezer. One or more walls may be made of a material which is able to be compressed, so as to extrude the flowable food product from at least one opening of the container upon receiving a compressive force from a device. One or more walls may be comprised of one or more papers, waxes, polymers, metals, the like, or any combination thereof. A wall may be comprised of a composite foil of any combination of the one or more wall materials. A wall material may be comprised of a composite foil having one or more polymers and one or more metals. A paper may be coated with a wax and/or polymer. Paper may comprise a cardstock, paperboard, cardboard, the like, or any combination thereof. A polymer may include a plastic, such as a thermoplastic. A thermoplastic may be particularly useful in allowing the one or more walls to be shaped. A polymer may include polyethylene, polyester, polypropylene, the like, or any combination thereof. A metal may include aluminum, copper, stainless steel, the like, or any combination thereof. One or more of the wall materials may be a foil, film, or both. For example, one or more wall materials may be a plastic film. One or more wall materials may be heat molded and/or vacuum shaped to form one or more walls.

One or more walls may include one or more identifiers. One or more identifiers may function to identify the flowable food product within the container, properties of the flowable food product, and/or relay information to one or more sensors. One or more identifiers may include one or letters and/or numbers, barcodes, QR codes, RFID, and/or the like. The one or more identifiers may contain data related to the container and/or flowable food product within the container. Data may include flavor, serving temperature, rate of compression, expiration date, the like, or any combination thereof

One or more walls may include condition sensitive inks. Condition sensitive inks may change colors when exposed to light and/or heat. Condition sensitive inks may include thermochromic ink. Condition sensitive inks may be used to identify when a flowable food product within a container has reached a temperature suitable for dispensing from a device.

One or more walls may have a wall thickness. The wall thickness may function to store and transport a flowable food product, allow the one or more walls to be compressed or deformed by application of a compressive force during dispensing, or both. One or more walls may have a wall thickness of about 1 mil or greater, about 1.5 mil or greater, or even about 2 mil or greater. One or more walls may have a wall thickness of about 6 mil or less, about 5 mil or less, or even about 4 mil or less.

The container may include one or more inserts. An insert may function to dispense and/or guide a flowable food product from the container. An insert may cooperatively work with one or more walls, a device for serving the flowable food product into a serving container, or both. An insert may have any size and/or shape suitable for being retained within one or more walls or being affixed to one or more walls. For example, an insert may have a cross-section shape which is square, rectangular, oval, elliptical, circular, triangular, the like, or a combination thereof. An insert may have a cross-section substantially the same, similar, or identical to a cross-section of one or more walls, such as a circular cross-section of the first wall and/or bottom end wall. The insert may be generally curved (i.e., convex and/or concave), planar, or both. For example, the insert may be generally disc-shaped and concave. An insert may have a width (e.g., diameter) and/or thickness smaller than, equal to, or greater than one or more walls of the container. An insert may have a width suitable for residing within a hollow interior of the container. An insert may have a width (i.e., outer diameter) about equal to or less than an internal width of the one or more walls. An insert may be located within the one or more walls. One or more inserts may be between, adjacent to, in contact with, and/or distanced from one or more walls. An insert may rest directly on a bottom end wall. An insert may be distanced from and opposing a sealing wall. An insert may be located between a sealing wall and a bottom end wall. An insert may be centered or off-center with one or more walls, one or more wall openings, or both. An insert may include one or more insert openings. The insert may include one or more nozzles. One or more nozzles may project from a surface of an insert. An insert may be formed separately from or simultaneously with one or more walls. An insert may be a separate piece or integral with one or more walls. An insert may be affixed to one or more walls. An outer perimeter of an insert may be affixed to an interior diameter of one or more walls, such as a first wall. A surface of an insert may be affixed to an interior surface of one or more walls, such as a bottom end wall. An insert may be affixed to one or more walls via any suitable attachment means. A suitable attachment means may include an adhesive, welding, friction, locking tabs, mating features, or a combination thereof. An insert may be ultrasound welded to the interior, exterior or some combination of one or more walls. An insert may be ultrasound welded to a bottom end wall within the hollow interior of the container. An insert may be uncompressible, undeformable, inflexible, and/or rigid. An insert may be comprised of one or more insert materials.

One or more inserts may be comprised of one or more insert materials. One or more insert materials may function to retain the shape of one or more inserts when a compressive force is applied to the container, guide flow of a flowable food product when dispensed from the container, or both. One or more insert materials may be substantially uncompressible, undeformable, inflexible, and/or rigid when receiving a compression force from a device. By having one or more insert openings and remaining rigid or stiff, an insert may guide a flowable food product out the one or more insert openings, allow the flowable food product to exit in a vortex motion, guides the flowable food product to be dispensed in a swirl shape, prevent the flowable food product from contact the device during extrusion or dispensing, guide the flowable food product into a serving container, or a combination thereof. One or more insert materials may include any suitable material which may be uncompressible, undeformable, inflexible, safe for contact with a flowable food product, safe for storage in freezing temperatures, prevent contaminants from entering the container, biodegradable, recyclable, the like, or any combination thereof. One or more insert materials may be any suitable material for long-term food storage conditions, such as freezing temperatures within a freezer. One or more insert materials may include one or more of the one or more wall materials. One or more insert materials may include one or more papers, polymers, metals, the like, or any combination thereof. A polymer may include a plastic, such as a thermoplastic and/or thermoset. A polymer may include polyethylene, polyester, polypropylene, the like, or any combination thereof. A metal may include aluminum, copper, stainless steel, the like, or any combination thereof. One or more insert materials may be more stiff and/or rigid than one or more wall materials. For example, an insert may be comprised of a harder plastic than that of one or more walls.

One or more insert materials may have an insert thickness. An insert thickness may allow an insert to remain uncompressed or undeformed by application of a compressive force. An insert thickness may be less than, about equal to, or greater than one or more wall thicknesses. An insert thickness may be greater than a wall thickness. An insert thickness may be about 5 times or more greater (5:1 or greater) than a wall thickness, about 8 times or more greater (8:1 or greater) than a wall thickness, or even about 10 times or more greater (10:1 or greater) than a wall thickness. An insert thickness about 16 times or less greater (16:1 or less) than a wall thickness, about 14 times or less greater (14:1 or less) than a wall thickness, or even about 12 times or less greater (12:1 or less) than a first wall thickness.

The container may include one or more openings. One or more openings may function to allow flowable food product to exit from the container, guide extrusion of a flowable food product from the container, prevent contact of flowable food product with a device, or any combination thereof. Guiding may include guiding flowable food product into a serving container, preventing contact of the flowable food product with a surface of the device, guiding an exit motion of the flowable food product form the container, guiding a serving shape of flowable food product into a serving container, or any combination thereof. One or more openings may be located in one or more walls, one or more inserts, or both. One or more openings in one or more walls may be defined as one or more wall openings. One or more openings in one or more inserts may be defined as one or more insert openings. One or more openings may be aligned with one or more other openings. Aligned may be centered or off-center. By being aligned with, one or more openings allow the flowable food product to travel through with minimal resistance. One or more openings may have a shape to guide exit motion of the flowable food product. Exit motion of a flowable food product may include a vortex motion. One or more openings may be any shape to guide or create a specific serving shape of the flowable food product, such as a swirl (i.e., ice cream cone swirl) within a serving container. One or more openings may allow a flowable food product to be dispensed into a serving container with a swirl shape, without additional movement of the serving container. One or more openings may have a shape which is generally circular, square, rectangular, triangular, heart-shaped, star-shaped (i.e., a five or six point stair), the like, or any combination thereof. One or more openings may have a different shape than one or more other openings. One or more insert openings may have a different shape than one or more wall openings. For example, one or more wall openings may be generally circular while one or more insert openings are heart or star-shaped. One or more openings may be formed as cut-outs within one or more walls, inserts, or both. One or more openings may include one or more grooved surfaces. Grooved surfaces may be useful in creating a vortex motion as the flowable food product flows through the opening. One or more openings may be formed within a nozzle.

The container may include one or more nozzles. A nozzle may function to guide a flowable food product outside of the container while preventing contact with one or more surfaces of a receptacle, provide a serving shape of a flowable food product within a serving container, or both. A nozzle may be part of one or more one or more walls, one or more inserts, or both. A nozzle may be separate or integral with one or more walls, one or more inserts, or both. A nozzle may project from a surface of one or more walls, one or more inserts, or both. A nozzle may project away from a hollow interior of the container. A nozzle may include one or more openings. For example, if the nozzle is integral with and projects from an insert, an insert opening may extend through the nozzle. One or more nozzles may be aligned, extend through, or both with one or more other openings. A nozzle may be centered with and extend through a wall opening. An interior of a nozzle may include one or more grooves. The one or more grooves may swirl a flowable food product in a vortex motion as the flowable food product moves from within the container to external of the container.

One or more openings of the container may have a width and/or cross-sectional area. The width and/or cross-sectional area may function to allow the flowable food product to exit the container at a pace similar to a pace the container may be being compressed by a device. A width may be a diameter if the opening is circular. A width may be the largest or smallest width of an opening if the opening has a shape with multiple contours (e.g., heart and/or star shaped). One or more openings may have a width and/or cross-sectional area smaller, about equal to, or larger than one or more other openings. An insert opening may have a width and/or cross-sectional area about smaller than or about equal to a width and/or cross-sectional area of one or more wall openings, one or more receptacle openings, or both. One or more openings may include a width about equal to 60 mm or less, about equal to 50 mm or less, about equal to 40 mm or less, or even about equal to 30 mm or less. One or more openings may include a width of about 10 mm or greater, about 20 mm or greater, or even about 25 mm or greater. One or more openings may include a cross-sectional area of about 500 mm² or greater, about 600 mm² or greater, about 650 mm² or greater, or even about 700 mm² or greater. One or more openings may include a cross-sectional area of about 2700 mm² or less, about 2600 mm² or less, about 2550 mm² or less, or even about 2500 mm² or less. The container may be able to prevent the flowable food product from exiting the container via one or more openings prior to a user desiring to serve the flowable food product via a covering device.

The container may include one or more covering devices. One or more covering devices may function to maintain a flowable food product within a container before a user desires to dispense the flowable food product, expose an opening when a user desires to serve a flowable food product, or both. A covering device may be formed as a tab, cap or any similar device useful for covering one or more openings. A covering device may be removably affixed to the container. A covering device may be located at top, bottom, or side of a container. A covering device may be located over one or more openings of a container. A covering device may be located on an exterior surface of a wall, such as a bottom end wall. A covering device may be located on a surface of an insert, such as a nozzle. A covering device may be screwed onto a portion of the container, such as a nozzle. A covering device may be sized to allow a user to grip the covering device and remove the covering device with a grip, such as a pinch grip. A covering device may include threads to screw on and off of a nozzle. A covering device may be welded to one or more walls, one or more inserts, or both. A tab may be welded onto one or more walls on an exterior bottom end wall to cover one or more openings. A covering device may be a screw-on lid. A covering device may be made of any suitable material which may be removably affixed to a surface of the container, such as a wall. For example, the covering device may comprise a plastic material. A covering device may be made of any materials suitable for one or more wall materials, one or more insert materials, or both. A covering device may be made as the same or different material as an insert.

The teachings herein relate to a device which may be used for dispensing a flowable food product. The device may be particularly useful in serving a flowable food product stored within a container of the teachings herein. A flowable food product may include ice-cream, soft-serve, frozen yogurt, gelato, the like, or a combination thereof into a serving container. The device may be useful in commercial environments, such as restaurants or stores. The device may be particularly useful in consumer environments, such as a consumer's home. The device may be sized to fit on a surface of a home, such as a table top or kitchen counter. The device may include a frame to support and/or house one or more components.

The device may include a frame. The frame may function to support and/or house one or more components of the device, provide an aesthetically appealing design of the device, or both. A frame may include one or more structures for retaining one or more plungers, one or more receptacles, one or more actuator assemblies, one or more control panels, one or more electrical wires and connections, or any combination thereof. A frame may include one or more surfaces for resting the device on a surface, such as a countertop. A frame may include one or more surfaces for resting and/or receiving a serving container. A frame may include one or more drawers for concealing one or more receptacles.

A frame of the device may include one or more bases. A base may function to support and/or house one or more components of the device, provide a serving container surface, support at least some of the weight of the device, or any combination thereof. A base may be a part of the device frame. A base may have any shape suitable for supporting and/or housing one or more components of the device. A base may provide a resting surface for placing a serving container. A resting surface for placing the serving container may be directly underneath a plunger, receptacle, and/or receptacle opening of the device. A resting surface may include a retaining feature for retaining a serving container. A retaining feature may include one or more protrusions, an opening, a funnel, a holder, the like, or a combination thereof. For example, one or more protrusions may project from the resting surface or be indented into the resting surface to hold a cone shaped serving container (i.e., pastry cornet for receiving ice-cream) or a bowl-shaped serving container. A base may provide support for and/or enclose at least part of an actuator assembly. A base may support a motor, a drive shaft, a motor gear, a movement rod gear, or a combination thereof. A base may house one or more electrical components. A base may be connected to a back support.

A frame may include one or more back supports. A back support may function to provide support for a first connector portion, house one or more components of the device, provide stability for the device, or any combination thereof. A back support may be part of a device frame. The back support may project or extend from the base. A back support may be integral with and/or affixed to the back support. A back support may be perpendicular to the base. A back support may have a height about equal to the overall height of the device. An overall height of the device, the frame, or both may about less than, equal to, or greater than a typical distance from a counter top to an upper cabinet. The height of the device may allow the device to fit between a counter top and an upper cabinet (i.e., wall mounted cabinet above base cabinets), such as in a typical residential kitchen. The overall height of the back support, the device, the frame, or a combination thereof may be about equal to or greater than 10 inches, about equal to or greater than 12 inches, or even about equal to or greater than 14 inches. The overall height of the back support, the device, the frame, or a combination thereof may be about equal to or less than 20 inches, about equal to or less than 18 inches, or even about equal to or less than 16 inches. The back support may house one or more electrical components, one or more actuator assemblies, one or more control panels, or any combination thereof. A back support may have a control panel affixed thereto. A back support may be connected to a first connector portion.

A frame may include one or more first connector portions. The first connector portion may function to provide support for one or more components of the device; cooperate with an actuator assembly, a plunger, a receptacle, or any combination thereof. A first connector portion may extend or project from the back support. A first connector portion may project generally perpendicularly from the back support. A first connector portion may project from a top of the back support. A first connector portion may be parallel and distanced from the base. Preferably, the first connector portion is distanced from the base by about a same distance as a length of the movement rod. A first connector portion may include or be affixed to a plunger. During dispensing of a flowable food product, a first connector portion may remain static, fixed, and/or mobile relative to one or more other components of the device. By remaining static, a height of the device may remain substantially the same during and after dispensing of a flowable food product. A first connector portion may be fixed relative to the rest of the frame such that it remains static during dispensing. A first connector portion may be in moveable communication with an actuator assembly to move toward a base, receptacle, or both during dispensing. Movement of a first connector portion may result in corresponding movement of a plunger. A first connector portion may provide support for a one or more components of an actuator assembly. A first connector portion may have a control panel affixed thereto. The first connector portion may be affixed to a plunger.

The device may include one or more plungers. The plunger may function to extrude a flowable food product from within a container; apply a compression force to a container and/or to a receptacle; compress a container to provide for extrusion of a flowable food product from the container; or any combination thereof. The plunger may extend or project one or more components of a frame, such as a first connector portion. The plunger may project perpendicularly from the first connector portion. A plunger may have any suitable shape for applying a force to a container, compressing a container, being received by a receptacle which includes a container, or a combination thereof. The plunger may have a shape substantially similar and/or reciprocal to an interior of a receptacle, a portion of a container, or both. The plunger be substantially cylindrical, cubed, prismed, trapezoidal, elliptical, triangular, planar, the like, or any combination thereof. The plunger may by curved (i.e., convex or concave). The plunger may be stationary, laterally moveable, or both relative to one or more components of the device. The plunger may remain stationary. By remaining stationary, the overall height of the device may be suitable for consumer table or counter use. Alternatively, the plunger may be laterally moveable relative to base surface, a first connector portion, a receptacle potion, or any combination thereof. The plunger may be able to move toward the receptacle at a steady and/or varying rate. The plunger may have an overall exterior width (i.e., diameter). The plunger width may be about equal to or less than an interior width of a receptacle. The plunger width may be less than an interior width of a receptacle so that the plunger may be received by and within the receptacle. The plunger may be located concentrically or aligned with a receptacle, a serving container surface, or both. The plunger may come into communication with or be received by a receptacle upon activation of an actuator assembly. The plunger may come into contact with one or more walls of a container upon activation of an actuator assembly. The plunger may contact a sealing wall and/or first wall of a container, apply a compressive force to a container, or both upon activation of an actuator assembly.

The device may include one or more actuator assemblies. An actuator assembly may function to drive or move a receptacle toward and/or away from a plunger, a plunger toward and/or away from a receptacle, or both. The actuator assembly may linearly move one or more components of the device. One or more parts of the actuator assembly may be affixed to one or more components of the device to move them linearly toward and/or away relative to a base surface, receptacle, plunger, or any combination thereof. One or more components may include a first connector portion, a plunger, a receptacle, a second connector portion, a receiver portion, or any combination thereof. The actuator assembly may include a rotary to linear actuator, a pneumatic linear actuator, a hydraulic linear actuator, or any combination thereof. A rotary to linear actuator may include a motor, a drive shaft, a motor gear, a movement rod gear, and/or a movement rod. A hydraulic linear actuator and/or pneumatic linear actuator may include one or more rods, one or more pistons, and/or one or more cylinders. One or more pistons may move within the cylinder under increased or decreased pressure within the cylinder. One or more pistons may be fixed to one or more rods such that movement of the one or more pistons results in the same movement of the one or more rods. One or more rods may be affixed to a first connector portion, second connector portion, plunger, receptacle, or any combination thereof to result in in movement of the plunger and/or receptacle relative to one another. The actuator may include a sled affixed to the first connector portion, plunger, second connector portion, receptacle, or both. A sled may be the portion of an actuator assembly which is driven linearly in an upward and/or downward direction. By activating an actuator, the sled may move linearly upward and/or downward and transfer the motion to the first connector portion, plunger, second connector portion, and/or receptacle so as to drive the receptacle and/or plunger toward and/or away from the plunger and/or receptacle.

An actuator assembly may include a gear mechanism. The gear mechanism may function to convert rotational movement into linear movement, transfer a first direction and/or second direction of torque, or both. The actuator assembly may include a motor. The motor may function to provide energy to one or more rotary to linear converters, such as a movement rod and a receiving portion or provide power to an actuator. The motor may generate and transfer a first direction of torque, a second direction of torque, or both either directly or indirectly to a movement rod. The motor may be any power supply that may rotate the movement rod, linearly move a sled, move a receptacle toward or away from the plunger, or a combination thereof. The motor may function to provide pressure to one or more other components of an actuator assembly to result in movement. The motor may function to increase and/or decrease pressure within a cylinder. The motor may be an electric motor, a pneumatic power supply, a hydraulic power supply, another power supply, or any combination thereof, that is capable of driving a receptacle and/or plunger linearly, such as towards and/or away from a plunger and/or receptacle.

An actuator assembly may include a drive shaft. A drive shaft may function to transfer torque from a motor to one or more other components (i.e., gears) of an actuator assembly. The motor may rotate a drive shaft. By applying the first direction of torque, the drive shaft may rotate in a first direction. By applying the second direction of torque, the drive shaft may rotate in a second direction. The drive shaft may be in rotatable communication with one or more gears of the gear mechanism. The drive shaft may be rotatably connected to a motor gear.

An actuator assembly may include a motor gear. A motor gear may function to transfer torque to one or more other gears of an actuator assembly. A motor gear may transfer the first direction of torque, the second direction of torque, or both to a movement rod gear. The movement rod gear may be part of the gear mechanism. The movement rod gear may be in rotatable communication with a movement rod.

The device may include a movement rod. The movement rod may function to convert rotational movement into linear movement; transfer torque from the actuator assembly to one or more components of the device, or any combination thereof. One or more components of the device may include a first connector portion, a plunger, a receiving portion, a second connector portion, a receptacle, or a combination thereof. The movement rod may function to linearly move a receiving portion, a second connector portion, a receptacle, or any combination thereof. The movement rod may be any rotary to linear actuator which translates rotational movement of the gear mechanism into linear movement to linearly move the first connector portion, plunger, receiving portion, the second connector portion, the receptacle, or any combination thereof. The movement rod may receive torque from the actuator assembly, such as from the motor. An input portion of the movement rod may be in communication with one or more gears. For example, an input portion of the movement rod may be inserted within a female portion adapted for receiving the input portion of the movement rod gear. The input portion may receive torque from the motor, such as through the motor gear, the movement rod gear, the like, or a combination thereof. The movement rod may include an output portion. The output portion may be a threaded segment. The output portion may be engaged with a first connector portion, a plunger, a receiving portion, a second connector portion, a receptacle, or any combination thereof. The output portion may be engaged with a threaded segment of a receiving portion. The output portion may be located within an interior bore of a receiving portion. As the movement rod rotates in a first direction, a second direction, or both a threaded segment of the receiving portion may move linearly along the movement rod. For example, as the movement rod rotates in a first direction, the receiving portion may move linearly upward along the movement rod. For example, as the movement rod rotates in a second direction, a receiving portion may move linearly downward along the movement rod.

The device may include one or more receiving portions. The receiving portion may function to cooperate with a movement rod to move a first connector portion, a plunger, a second connector portion, a receptacle, or any combination thereof. A movement rod may transfer torque from the actuator assembly to a receiving portion to move a first connector portion, plunger, second connector portion, a receptacle, or both. Rotation of the movement rod may cause the receiving portion to move axially along a length of the movement rod. During a first direction of torque, the movement rod may be rotated in a first direction. During a second direction of torque, the movement rod may be rotated in a second direction. A first direction may cause the receiving portion to axially move upward along a length of the movement rod, away from a base, toward a first and/or connector portion. During a second direction of torque, the movement rod may be rotated in a second direction. A second direction may cause the receiving portion to axially move downward along a length of the movement rod, toward the base, and/or away from a first connector portion. The receiving portion may be connected to a second connector portion, a receptacle, or both such that the first direction of torque may move the receptacle toward the plunger, such that the plunger may be received by the receptacle and may compress a container within the receptacle. The receiving portion may be connected to a second connector portion, a receptacle, or both such that the second direction of torque may move the receptacle away from the plunger.

The device may include a second connector portion. A second connector portion may function to connect a receiving portion to a receptacle; retain a receptacle static relative to movement of a plunger, move a receptacle relative to a plunger, transfer linear movement of a receiving portion to a receptacle, or any combination thereof. A second connector portion may be any suitable size or shape to hold the weight of the receptacle. Weight of the receptacle may include weight of the receptacle plus a container, a weight of the receptacle when a plunger is applying a compressive force into a container located within the receptacle, or both. A second connector portion may extend from a receiving portion. The second connector portion may extend away from the receiving portion and away from the back support. The second connector portion may include one or more arms. One or more arms may include a first arm. A first arm may be substantially horizontal; parallel to a base, first connector portion, or both; or any combination thereof. A first arm may be affixed to a receiving portion, a receptacle, or both. One or more arms may include a second arm. A second arm may be parallel, perpendicular, or any angle therebetween relative to the first arm. A second arm may be affixed to a receiving portion at a different location than a first arm. A second arm may be affixed at a lower end of the receiving portion than the first arm. The second arm may be affixed to the receptacle at the same location as the first arm. The second arm may provide additional support to the first arm, the receptacle, or both.

The device may include one or more receptacles. A receptacle may function to hold a container for dispensing a flowable food product; cooperate with a plunger to compress a container for dispensing a flowable food product; allow flowable food product to exit from the receptacle after exiting the container into a serving container; or any combination thereof. The receptacle may be removably affixed to a frame, receiving portion, a second connector portion, back support, or any combination thereof. A receptacle may reside within a drawer, a pivotable shelf, or the like of the frame. The receptacle may be removably affixed to the frame so as to allow removal for cleaning and reattachment for use. The receptacle may have any size or shape suitable for holding a container, receiving a plunger, or both. The receptacle may have a complimentary shape for receiving a container, such as the container of the teachings herein. The receptacle may have a shape substantially similar to a container of the teachings herein. The receptacle may be generally cylindrical, cubed, prismed, trapezoidal, elliptical, and/or triangular shaped. The receptacle may have a hollow interior to allow a container to be placed within. The receptacle may include one or more sensors adjacent to or within a hollow interior. The receptacle may be free of an end wall at an upper end. By being free of an end wall, a plunger is able to move in and out of the receptacle hollow interior. The receptacle may include a bottom end. The bottom end may provide support for a bottom of a container. The bottom end may apply a reaction force to that of a plunger, a compression force, or both. The receptacle may work with the plunger to compress a container, such as to extrude a flowable food product from the container. The receptacle may be stationary, laterally moveable, or both relative to one or more components of the device. The receptacle may remain stationary. Alternatively, the receptacle may be laterally moveable relative to base and/or plunger. The receptacle may be able to move toward the plunger at a steady and/or varying rate. As a receiving portion moves in a first direction or upward, the receptacle may move towards the plunger. Alternatively, as a plunger moves in a first direction or downward, a plunger moves toward the receptacle. The plunger is received by the receptacle and compresses the container. By compressing the container, the flowable food product is extruded from the container and flows out of at least one opening of the container and flows out of the at least one receptacle opening, such as into a serving container located below the receptacle.

The device may include one or more receptacle openings. A receptacle opening may function to allow flowable food product to exit from the receptacle upon exiting the container. A receptacle opening may be smaller than, about equal to, or larger than one or more openings of a container. A receptacle opening larger than a container opening may allow a flowable food product to exit the receptacle without contacting a surface of the receptacle. A receptacle opening may be aligned (i.e., generally centered) with at least one opening of a container, when the container is located within the receptacle.

The device may include one or more drawers. One or more drawers may function to conceal and/or provide access to one or more receptacles. One or more drawers may be a drawer, door, shelf, the like, or any combination thereof capable of providing access and concealing a receptacle. One or more drawers may include a receiving area for retaining one or more receptacles. The receiving area may have a shape generally complimentary (i.e., substantially the same) as one or more receptacles. One or more drawers may open away from the frame (i.e., a back support) to provide access to the receptacle, close into the frame (i.e., toward the back support) to conceal the receptacle, or both. One or more drawers may be mounted to the frame via one or more hinges, springs, rails, or any combination thereof. A drawer may be connected to a second connector portion or may be disconnected. A drawer may move with a receptacle during dispensing of a flowable food product or may remain steady.

The device may include one or more activation buttons. The one or more activation buttons may function to provide or communicate power to an actuator assembly; initiate movement (e.g., linear or axial) of the receptacle and/or plunger towards and/or away from a plunger and/or receptacle; or both. The one or more activation buttons may be located on a control panel, a portion of the frame, or a combination thereof. The one or more activation buttons may be located on a side of the back support, a base surface, a side of a first connector portion, or any combination thereof. For example, a control panel may be affixed to both a back support and a connector portion and the activation buttons may be located on the control panel. The one or more activation buttons may include a power button to turn the device on and/or off. The one or more activation buttons may have an engagement or start button to initiate movement of the receptacle and/or plunger toward a plunger and/or receptacle. The one or more activation buttons may have a stop button to stop movement of the receptacle and/or plunger toward the plunger and/or receptacle. The one or more activation buttons may include a reverse button to reverse movement of the receptacle and/or plunger such that it moves away from the plunger and/or receptacle. One or more activation buttons may be provided as a single button or as a plurality of buttons. For example, the power button, the start button, the stop button, the reverse button, the like, or a combination thereof may be provided as a single button on the control panel or as a plurality of buttons on the control panel. The one or more activation buttons may be electrically connected to one or more electrical components.

The device may include one or more electrical components. The one or more electrical components may function to provide power (electrical current), transfer power, send electrical signals, sense the presence of certain conditions, the like, or a combination thereof. The one or more electrical components may be located within any component of the device, such as the frame, a control panel, the receptacle, the actuator assembly, the like, or any combination thereof. The one or more electrical components may include electrical wiring, one or more sensors, one or more scanners, one or more communication systems, or any combination thereof. Electrical wiring may be in communication with any component of the device to transfer electrical current, signals, or both. One or more electrical wires may be in electrical communication between the one or more activation buttons and the actuator assembly, a power source (i.e., power outlet) and the actuator assembly, one or more sensors and a control panel, or any combination thereof. One or more electrical wires may be compatible with and/or include one or more outlet plugs for use with one or more power outlets. Power outlets may include any known electrical outlet plug, such as any of the Type A-Type O plugs and sockets. Power outlets may be compatible with any type of known outlet, such as 110V or 220 V. Electrical wiring compatible with 110V allows the device to be easily plugged in and powered within a residential home. The electrical wiring may transfer power, electrical signals, or both from the activation buttons to the actuator assembly, such as to allow the activation buttons to control and activate the actuator assembly. The electrical wiring may be connected to one or more sensors.

The device may include one or more sensors. The sensors may be located on the frame, the receptacle, the plunger, or any other component of the device. The sensors may sense the presence of a container, such as a container within the receptacle and/or a serving container on the base. A sensor may sense one or more conditions of the container. One or more conditions may include temperature, weight, type of flowable food product stored within the container, the like, or any combination thereof. A sensor may include a scanner which may read one or more identifiers. A sensor may communicate to a control panel the one or more conditions of the container. The control panel may then determine a speed of linear movement of a plunger, receptacle, or both via an actuator assembly. For example, one of more flowable food products may have a higher or lower sugar content than one or more other flowable food products; and a speed of the plunger, receptacle, or both for applying a compressive force may be increased and/or decreased based upon the sugar content. A sensor may sense the completion of a serving of a flowable food product, an overflow condition of the flowable food product, or a combination thereof. A sensor and/or control panel in the receptacle may determine if a correct container has been placed within the receptacle, a temperature and/or weight of the container, a type of flowable food product, or any combination thereof. A sensor in the receptacle and/or a control panel may determine, such as by weight, when a container within the receptacle has been emptied. A sensor in the receptacle and/or a control panel may determine if there is a problem dispensing, such as a removable tab is still present on the container. A sensor on the base may determine, such as by weight, whether a serving container is present, empty, full, the like or a combination thereof. A sensor on a base may determine an overflow or overfill condition, such as by sensing flowable food product coming into contact with the base. The one or more electrical components may further include one or more displays, such as a digital display. The one or more displays may be located on the frame, the control panel, or any other component of the device. The one or more displays may display the time remaining to dispense a flowable food product, an error message, the power condition (on/off) of the device, instructions to relay a method of use to a user, or a combination thereof

The device may include one or more connection systems. The one or more communication systems may function to allow communication between the device and one or more other electronic devices. One or more other electronic devices may include one or more tablets, computers, cellular phones, home integration systems (e.g., smart home systems), intelligent personal assistants, the like, or any combination thereof. One or more communication systems may be wired and/or wireless. Wired may include one or more ethernet cables, coaxial cables, optical cables, the like, or any combination thereof. One or more wireless connection systems may include one or more wireless internet receivers, bluetooth, the like, or any combination thereof. One or more connection systems may be in electrical communication with one or more other electrical components. One or more connection systems may reside within the frame. One or more connection systems may allow a user to control, obtain a status, obtain information and/or receive help for the device; order new components; or any combination thereof through an electronic device. A user may be able to control the actuator assembly through one or more electronic devices. A user may be able to order components for the device through one or more electronic devices. A user may be able to purchase additional containers through one or more electronic devices. Through one or more connection systems, one or more electronic devices may provide instructions regarding a method for using the container, the device, or both.

The teachings herein further relate to a method of using the container, the device, or both as disclosed herein. The method may provide a method to serve a flowable food product, such as a dessert, into a serving container. The method may provide a method to use a device, a container, or both to dispense a flowable food product. The method may include locating the container into a receptacle having a complimentary shape for receiving the container. The method may include moving the container and receptacle into contact with a plunger and/or moving a plunger into contact with the container. The method may include compressing the container contents by continued movement toward the plunger and/or receptacle so that the container contents exit the container via at least one opening of the container.

The method of the disclosure may further include any of the following steps, in any combination: depressing one or more activation buttons to power a device on and/or off; removing a tab, removing a tab and/or cap which covers one or more openings of a container, removing a tab and/or cap prior to locating a container into a receptacle; activating movement of a container, receptacle, plunger, or any combination thereof; depressing one or more activation buttons to activate movement of the container, plunger, and/or receptacle; the method may be free of direct contact between contents within the container, such as flowable food product, and a plunger; moving a container, receptacle, and/or plunger downward; moving a container, receptacle, or both away from a plunger; moving a plunger away from a container and/or receptacle; placing or locating an empty serving container on the device; placing an empting serving container on the base; filling a serving container with flowable food product; removing a serving container with flowable food product from the device; removing a container from the device; removing a deformed or compressed container from the device; removing a deformed or compressed container from the receptacle of the device; removing the receptacle from the device; detaching the receptacle from the second connector portion, the receiving portion, an actuator assembly, a drawer, or a combination thereof; cleaning the receptacle; affixing or attaching the receptacle to the device; affixing or attaching the receptacle to a second connector portion, a receiving portion, an actuator assembly, a drawer, or a combination thereof.

### Illustrative Embodiments

The following descriptions of the Figures are provided to illustrate the teachings herein, but are not intended to limit the scope thereof

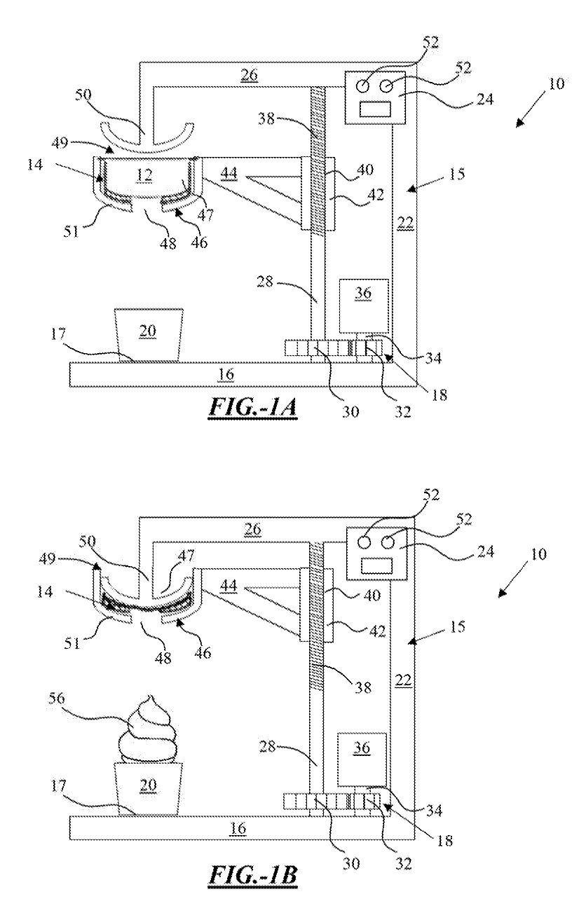

FIGS. 1A and 1B illustrate a side view of a device 10 for dispensing a flowable food product 12. FIG. 1A specifically illustrates the device 10 prior to dispensing a flowable food product 12 from a container 14 and FIG. 1B illustrates the device 10 after dispensing a flowable food product 12. The device 10 includes a frame 15. The device 10 includes a base 16. The base 16 provides support for an actuator assembly 18. The base 16 provides a resting surface 17. A serving container 20 may be placed on the resting surface 17. A back support 22 extends or projects vertically from the base 16. The back support 22 extends generally perpendicular from the base 16. The back support 22 provides support for a control panel 24. The back support 22 provides support for a first connector portion 26. A first connector portion 26 extends or projects from the back support 22. The first connector portion 26 projects perpendicularly from the back support 22. The first connector portion 26 is parallel and distanced from the base 16. Extending from the first connector portion 26 to the base 16 is a movement rod 28. The movement rod 28 is in rotatable communication with the actuator assembly 18.

The actuator assembly 18 is a gear-based linear actuator. The actuator assembly 18 includes a movement rod gear 30, a motor gear 32, a drive shaft 34, and a motor 36. The movement rod 28 is in rotatable communication with the movement rod gear 30 so the movement rod 28 is rotated or driven by the movement rod gear 30. The movement rod gear 30 is in rotatable communication with a motor gear 32. The motor gear 32 is rotatably driven by the drive shaft 34. The drive shaft 34 is driven by the motor 36. The movement rod 28 includes a movement rod threaded segment 38 along a portion of its length. The movement rod threaded segment 38 is engaged with a receiving portion threaded segment 40 of a receiving portion 42. Rotation of the movement rod 28 in a first direction results in the receiving portion 42 moving in a first direction (i.e., upward away from the resting surface 16) along the movement rod 28. Rotation of the movement rod 28 in a second direction (i.e., opposite of the first direction) results in the receiving portion 42 moving in a second direction (i.e., downward toward the resting surface 16) along the movement rod 28. Extending from the receiving portion 42 and away from the back support 22 is a second connector portion 44.

The second connector portion 44 extends generally perpendicular to the movement rod 28. The second connector portion 44 includes a receptacle 46. The receptacle 46 is generally cylindrically shaped with a hollow interior 47. The receptacle 46 is free of an end wall at an upper end 49. The upper end 49 faces toward and receives a plunger 50. The receptacle 46 includes a bottom end wall 51. The receptacle 46 includes a receptacle opening 48. The receptacle opening 48 is located in the bottom end wall 51. The receptacle opening 48 allows a flowable food product 12 to pass or flow through during dispensing. A container 14 is placed within the receptacle 46 during use of the dispensing device 10. As the receiving portion 42 moves in a first direction, the receptacle 46 moves towards a plunger 50. The plunger 50 is supported by the first connector portion 26. The plunger 50 projects vertically and downward (i.e., toward the resting surface 16) from the first connector portion 26. The plunger 50 is concentrically aligned with the receptacle 46 and a serving container 20.

The device 10 includes activation buttons 52. The activation buttons 52 are located on a control panel 24. The activations buttons 52 are in electrical communication with the actuator assembly 18. Depressing at least one of the activation buttons 52 activates the actuator assembly 18. By activating the actuator assembly 18, the motor 36 drives the drive shaft 34 and/or motor gear 32 in a first direction, a second direction, or both. By depressing at least one of the activation buttons 52, the actuator assembly 18 drives the receiving portion 42, the second connector portion 44, and/or the receptacle 46 in a first direction (e.g., upwardly) and/or second direction (e.g., downwardly).

The dispensing device 10 disposes a flowable food product 12 by first locating a container 14 into a receptacle 46. The container 14 includes a tab 72 or cap 172 (not shown). The tab 72 or cap 172 may need to be removed from the container 14 prior to locating the container 14 into the receptacle. The container 14 contains a flowable food product 12. The receptacle 46 has a complimentary shape to receive the container 14. The receptacle 46 and the container 14 are moved towards a plunger 50. At least one of the activation buttons 52 is depressed to activate an actuator assembly 18. By activating the actuator assembly 18, the receptacle 46 and the container 14 move towards the plunger 50. The receiving portion 42 is affixed to a second connector portion 44 which is affixed to the receptacle 46. Upward movement of the receiving portion 42 results in upward movement of the receptacle 46 towards the plunger 50. As the receptacle 46 and the container 14 are moved upward and into contact with the plunger 50, the plunger 50 compresses the container 14, the flowable food product 12, or both between the plunger 50 and the bottom end wall 51. As the plunger 50 and bottom end wall 51 apply a compression force to both the container 14 and the flowable food product 12, the flowable food product 12 flows out of the container 14. Upon compression, the flowable food product 12 flows out through an opening 54 of the container 14. The flowable food product 12 exits the container 14 via an opening 54 (not shown) and exits the receptacle 46 through the receptacle opening 48. The flowable food product 12 flows into a serving container 20. The flowable food product 12 exits the container 14 and/or the receptacle 46 in a vortex motion. The vortex motion forms a swirled flowable food product 56 within the serving container 20.

FIG. 2 illustrates a side view of a device 10 for dispensing a flowable food product 12 (not shown). The device 10 includes a frame 15. The device 10 includes a base 16. The base 16 provides a resting surface 17. A serving container 20 may be placed on the resting surface 17. A back support 22 projects from the base 16. The back support 22 provides support for a control panel 24. The back support 22 provides support for a first connector portion 26. The first connector portion 26 projects from the back support 22. The first connector portion 26 is generally parallel and distanced from the base 16. An actuator mechanism 18 resides partially within the frame 15. The actuator mechanism 18 includes a rod 200. The rod 200 is fixed to the plunger 50. The rod 200 is also affixed to a piston 202. The piston 202 resides in a cylinder 204. Under pressure, the piston 202 move within the cylinder 204 in a first direction and/or second direction. A first direction (i.e., downward) is toward the receptacle 46 and a second direction (i.e., upward) is away from the receptacle 46. Movement of the piston 202 results in a corresponding movement of the rod 200 and plunger 50. Additionally, the receptacle 46 includes a sensor 214. The sensor 214 is affixed to an interior of the receptacle 46. The sensor 214 is positioned within the receptacle 46 to detect a property of a container 14 (not shown) when the container 14 is located within the receptacle 46.

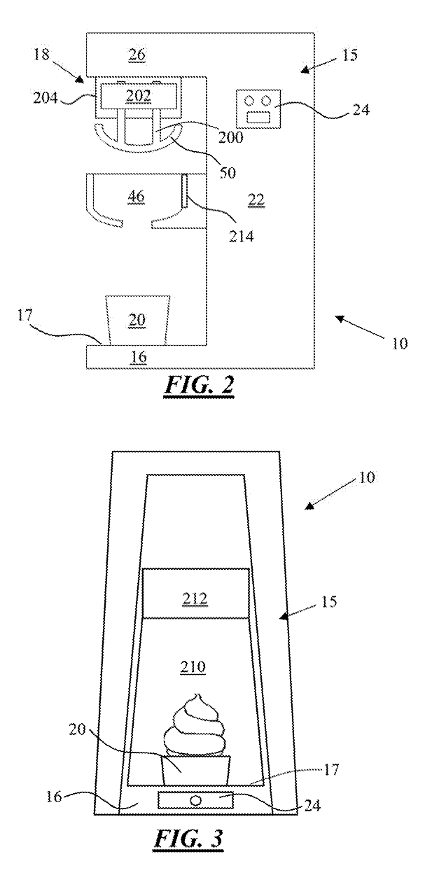

FIG. 3 illustrates a device 10. The device 10 includes a frame 15. The frame 15 conceals an actuator assembly 18 (not shown), receptacle 46 (not shown), and plunger 50 (not shown). By concealing these components, the frame 15 provides an aesthetically appealing housing. The frame 15 includes a base 16. The base 16 includes a resting surface 17. A serving container 20 is able to be located on the resting surface 17. The frame 15 includes a serving cavity 210. The serving cavity 210 allows the receptacle 46 to be located over the resting surface 17 while remaining concealed. The frame 15 includes a drawer 212. The drawer 212 includes the receptacle 46. The drawer 212 is able to open outward to provide access to the receptacle 46 (not shown) to insert a container 14 (not shown). The frame 15 further includes a control panel 24.

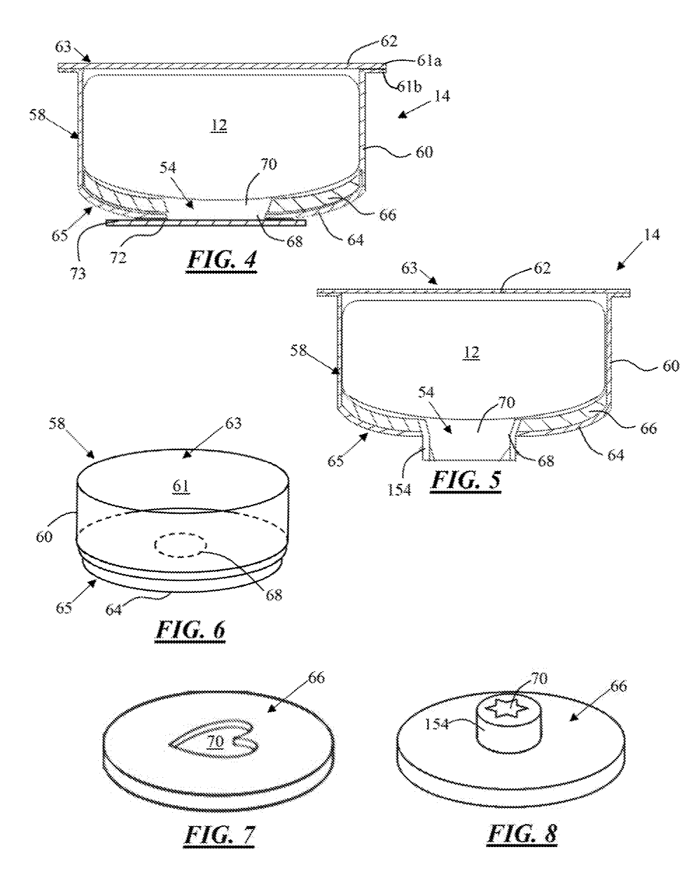

FIG. 4 illustrates a cross section of a container 14. The container 14 retains and stores a flowable food product 12. The container 14 includes a wall 58. The wall 58 is compressible. The wall 58 includes a first wall 60 which is substantially cylindrical. The wall 58 includes a bottom end wall 64. The bottom end wall 64 is adjacent and integral with the first wall 60. The bottom end wall 64 is located at a bottom end 65 of the container 14. The bottom end wall 64 is curved (i.e., concave). The bottom end wall 64 is opposite a sealing wall 62. The sealing wall 62 is located at a top end 63 of the container 14. The sealing wall 62 is substantially planar. The sealing wall 62 is adhered to the first wall 60 at flanges 61a, 61b. The sealing wall 62 covers the container 14 so that the flowable food product 12 is not exposed to an ambient environment. The container 14 includes an insert 66. The insert 66 is not be compressible and/or deformable. The insert 66 is curved such that it has a generally concave shape. The curvature of the insert 66 allows it to rest adjacent to the bottom end wall 64. Alternatively, the insert 66 may be generally planar and lie in a substantially parallel relationship with the sealing wall 62. The container 14 includes an opening 54. The opening 54 includes a wall opening 68 in the bottom end wall 64. The wall opening 68 is generally centered within the bottom end wall 64. The opening 54 includes an insert opening 70. The insert opening 70 is located within the insert 66. The insert opening 70 is generally centered within the insert 66. The insert opening 70 is aligned with the wall opening 68. The insert opening 70 is generally centered with the wall opening 68 to allow the flowable food to first exit the insert opening 70 and then the wall opening 68. The container 14 includes a tab 72. The tab 72 is removable. The tab 72 is located on the exterior of the container 14. The tab 72 is located at the bottom end 65. The tab 72 covers the opening 54. The tab 72 includes a gripping portion 73.

FIG. 5 illustrates a cross section of a container 14. The container 14 retains and stores a flowable food product 12. The container 14 includes a wall 58. The wall 58 includes a first wall 60 which is substantially cylindrical. The wall 58 includes a bottom end wall 64. The bottom end wall 64 is adjacent and integral with the first wall 60. The bottom end wall 64 has a generally curved shape (i.e., concave). Alternatively, the bottom end wall 64 may be generally planar. The bottom end wall 64 is located at a bottom end 65 of the container 14. A sealing wall 62 is located at a top end 63 of the container 14. The container 14 includes an insert 66. The insert 66 is curved such that it has a generally concave shape. The insert 66 rests on the bottom end wall 64. The container 14 includes an opening 54. The opening 54 includes a wall opening 68 in the bottom end wall 64. The wall opening 68 is generally centered within the bottom end wall 64. The opening 54 includes an insert opening 70. The insert opening 70 is located within the insert 66. The insert opening 70 is formed through a nozzle 154. The nozzle 154 projects from the insert 66. The insert opening 70 and nozzle 154 are generally centered within the insert 66. The nozzle 154 extends through the wall opening 68. The nozzle 154 extends past the bottom end wall 64. The insert opening 70 may be closed off by a tab 72 (not shown) or a removable cap 172 (not shown).

FIG. 6 illustrates a wall 58 of a container 14 (not shown). The wall 58 includes a first wall 60. The first wall 60 is substantially cylindrical. Adjacent to the first wall 60 is a bottom end wall 64. The first wall 60 extends from a bottom end 65 to a top end 63. The first wall 60 encircles about a hollow interior 61. The hollow interior 61 provides for space to enclose a flowable food product 12 (not shown). The wall 58 includes a wall opening 68. The wall opening 68 is located in the bottom end wall 64.

FIG. 7 illustrates an insert 66 of the container 14 (not shown). The insert 66 has a generally circular, plate-like shape. The insert 66 may be generally planar or may be concave. The insert 66 includes an insert opening 70. The insert opening 70 extends through the entire thickness of the insert 66. The insert opening 70 has a heart-like shape. The insert opening 70 is generally centered within the insert 66.

FIG. 8 illustrates an insert 66 of the container 14 (not shown). The insert 66 includes a nozzle 154. The nozzle 154 projects from a surface of the insert 66. An insert opening 70 extends through an entire height of the insert 66. An insert opening 70 passes through the nozzle 154. The insert opening 70 has a star-like shape.

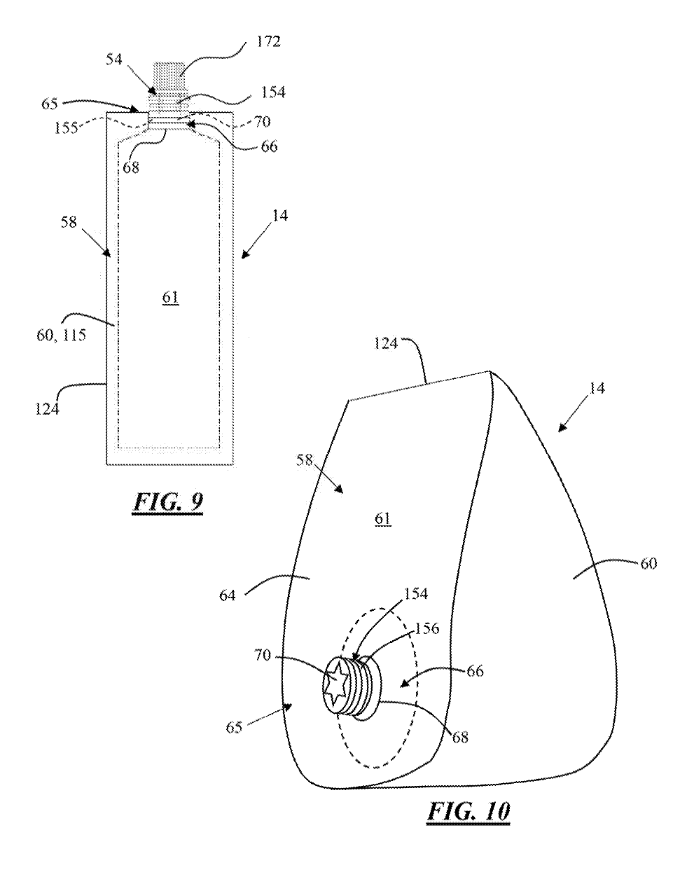

FIG. 9 illustrates a container 14. The container has a pouch-like shape. The container includes a wall 58. The wall 58 is in the shape of a pouch or other receptacle. The wall 58 includes a first wall 60. The first wall 60 is formed by opposing flexible panels 115. The opposing flexible panels 115 are sealed along edges 124 about the perimeter. The opposing flexible panels 115 form a hollow interior 61. The container 14 includes an opening 54. The opening 54 includes a wall opening 68. The wall opening 68 is an opening through the wall 58. The opening is located at the bottom end 65. The container 14 includes an insert 66. The insert 66 is located adjacent a bottom end 65. The insert 66 includes a nozzle 154. The nozzle 154 includes an insert opening 70 extending therethrough. The nozzle 154 passes through the wall opening 68. The nozzle 154 includes one or more grooves 155 along an interior diameter. The insert opening 70 is covered by a cap 172.

FIG. 10 illustrates a container 14. The container has a pouch-like shape. The container includes a wall 58. The wall 58 is a flexible sheet. The wall 58 is sealed along an edge 124 where edges 124 of the wall 58 come together. The wall 58 forms a hollow interior 61. When formed into a pouch-like shape, the wall 58 includes a first wall 60 and a bottom end wall 64. The bottom end wall 64 is relatively panel-shaped. The bottom end wall 65 is located at a bottom end 65 of the container 14. Adjacent to the bottom end wall 64 and within the hollow interior 61 is an insert 66. The insert 66 includes a nozzle 154. The nozzle 154 extends through a wall opening 68. The nozzle 154 is threaded 156. The nozzle 154 includes an insert opening 70. The insert opening 70 opens into the hollow interior 61.

### LISTING OF REFERENCE NUMERALS

10 Device
12 Flowable food product
14 Container
15 Frame
16 Base
17 Resting surface
18 Actuation assembly
20 Serving container
22 Back support
24 Control panel
26 First connector portion
28 Movement rod
30 Movement rod gear
32 Motor gear
34 Drive shaft
36 Motor
38 Movement rod threaded segment
40 Receiving portion threaded segment
42 Receiving portion
44 Second connector portion
46 Receptacle
47 Hollow interior of receptacle
48 Receptacle opening
49 Upper end of receptacle
50 Plunger
51 Bottom end wall of receptacle
52 Activation button
54 Opening of container
56 Swirled flowable food product
58 Wall
60 First wall
61a Flange of sealing wall
61b Flange of wall
62 Sealing wall
63 Top end of container
64 Bottom end wall
65 Bottom end of container
66 Insert
68 Wall opening
70 Insert opening
72 Tab
73 Gripping portion of tab
115 Flexible panel
124 Edge
154 Nozzle
155 Grooves
156 Threads of nozzle
172 Removable cap
210 Serving cavity
212 Drawer
214 Sensor

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints. The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

1. A container comprising:
(i) one or more walls which have a wall thickness of at least about 1.4 mil define a hollow interior, are compressible and deformable, and are adapted to encapsulate a flowable food product within the hollow interior;
(ii) one or more wall openings formed in at least one of the one or more walls;
(iii) one or more insert thickness that is greater than the wall thickness in a ration of at least about 10:1, is substantially rigid, generally planar, and is located adjacent and in direct contact with one of the one or more walls within the hollow interior;
(iv) one or more insert openings formed in the one or more inserts and centered with the one or more wall openings;
wherein the one or more walls are adapted to be compressed so as to extrude the flowable food product from the one or more wall openings and the one or more insert openings;
wherein the one or more insert openings are adapted to transfer an amount of flowable food product from within the container to a location exterior of the container; and
wherein the flowable food product is semi-solid.

2. (canceled)

3. The container of claim 1, wherein the wall thickness of the one or more walls is from at least about 1.5 to less than about 4.5 mil.

4. (canceled)

5. (canceled)

6. The container of claim 1, wherein the container includes a removable tab or cap that covers the one or more insert openings.

7. (canceled)

8. The container of claim 1, where the one or more wall openings and the one or more insert openings have a cross-sectional area of about 700 mm² or greater to at least about 2500 mm² or less.

9. The container of claim 1, wherein the one or more walls includes one or more first walls and one or more bottom end walls; and
wherein the insert is in direct contact with the one or more bottom end walls while confined between the one or more first walls.

10. (canceled)

11. The container of claim 1, wherein
the flowable food product is located within the hollow interior.

12. The container of claim 11, wherein the container is sealed about one or more edges of the one or more walls to prevent exposure of the flowable food product to an ambient environment.

13-20. (Canceled)

21. The container of claim 1, wherein the one or more walls are made of a plastic film.

22. The container of claim 6, wherein the container includes the removable tab which is located on an exterior surface of the one or more walls.

23. The container of claim 1, wherein the flowable food product is ice cream, frozen yogurt, gelato, pudding, gelatin, fruit purees, or a combination thereof.

24. The container of claim 1, wherein the one or more insert openings have a shape configured to dispense the flowable food product in a swirl shape into a serving container.

25. The container of claim 1, wherein the one or more insert openings have a shape which is heart-shaped, star-shaped, or both.

26. The container of claim 25, wherein the one or more insert openings have star-shaped to dispense the flowable food product in a swirl shape into a serving container.

27. A method of using a container, wherein the method comprises:
locating the container into a receptacle of a device having a complimentary shape for receiving the container;
(ii) moving the container and receptacle toward and into contact with a plunger of the device and/or moving the plunger toward the receptacle and toward and into contact with container; and
(iii) compressing one or more walls of the container by continued movement of the plunger and/or the receptacle so that a flowable food product is extruded from the container via one or more insert openings and one or more wall openings.

28. The method of claim 27, wherein the flowable food product exits the container in a vortex motion and forms a swirled shape in a serving container.

29. The method of claim 28, wherein the container comprises:
i) the one or more walls which have a wall thickness of at least about 1.5 mil, define a hollow interior, are compressible and deformable, and are adapted to encapsulate the flowable food product within the hollow interior;
ii) the one or more wall openings formed in at least one of the one or more walls;
iii) the one or more inserts having an insert thickness that is greater than the wall thickness in a ratio of at least about 10:1, is substantially rigid, generally planar, and is located adjacent and in direct contact with one of the one or more walls within the hollow interior;
iv) the one or more insert openings formed in the one or more inserts and centered with the one or more wall openings;
wherein the one or more walls are adapted to be compressed so as to extrude the flowable food product from the one or more wall openings and the one or more insert openings;
wherein the one or more insert openings are adapted to transfer an amount of the flowable food product from within the container to a location exterior of the container; and
wherein the flowable food product is semi-solid.

30. A device for dispensing a semi-solid flowable food product from within a container comprising:
(i) a frame;
(ii) a receptacle connected to the frame and adapted for retaining a container;
(iii) a plunger connected to the frame which is opposing and centered with the receptacle, wherein the plunger is adapted to be received within the receptacle;
(iv) an actuator assembly within the frame which is in communication with the receptacle, the plunger, or both and is adapted to generate movement of the receptacle, the plunger, or both; and
wherein movement of the receptacle and/or the plunger is relative to the other so that the plunger is able to be received within the receptacle to compress the container and extrude the semi-solid flowable food product.

31. The device of claim 30, wherein the receptacle includes one or more receptacle openings adapted for being aligned one or more openings of the container so the semi-solid flowable food product may be dispensed through the one or more openings and the one or more receptacle openings.

32. The device claim 31, including the container located into the receptacle, wherein the container includes:
i) one or more walls which have a wall thickness of at least about 1.5 mil, define a hollow interior, are compressible and deformable, and are adapted to encapsulate the semi-solid flowable food product within the hollow interior;
ii) one or more wall openings formed in at least one of the one or more walls;
iii) one or more inserts having an insert thickness that is greater than the wall thickness in a ratio of at least about 10:1, is substantially rigid, generally planar, and is located adjacent and in direct contact with one of the one or more walls within the hollow interior;
iv) one or more insert openings formed in the one or more inserts and centered with the one or more wall openings;
wherein the one or more walls are adapted to be compressed so as to extrude the semi-solid flowable food product from the one or more wall openings and the one or more insert openings;
wherein the one or more insert openings are adapted to transfer an amount of the semi-solid flowable food product from within the container to a location exterior of the container.

33. The device of claim 31, wherein the actuator assembly includes a rotary to linear actuator, a pneumatic actuator, a hydraulic actuator, or any combination thereof.
